(19) United States
(12) Patent Application Publication
(10) Pub. No.: US 2026/0085172 A1
(43) Pub. Date: Mar. 26, 2026

(54) POLYMERIZABLE COMPOSITION

(71) Applicant: Resonac Corporation, Tokyo (JP)

(72) Inventors: Masahiro AOSHIMA, Tokyo (JP); Yukino FUKUDA, Tokyo (JP); Yasuhiko YOSHINARI, Tokyo (JP); Toru TANAKA, Tokyo (JP); Takashi KAWAMORI, Tokyo (JP)

(21) Appl. No.: 19/109,392

(22) PCT Filed: Sep. 11, 2023
(86) PCT No.: PCT/JP2023/033071

§ 371 Date: Mar. 6, 2025

(30) Foreign Application Priority Data
Sep. 16, 2022 (JP) 2022-147808

(51) Int. Cl. C08K 5/55; C08K 5/092

(52) U.S. Cl. CPC C08K 5/55; C08K 5/092

(57) ABSTRACT

Provided is a polymerizable composition containing a polymerizable compound, the polymerizable composition containing: (A) a borate anion; and (B) at least one selected from the group consisting of an aromatic carboxylic acid having two or more hydroxy groups, a salt of the aromatic carboxylic acid, and a hydrate of the aromatic carboxylic acid.

### TECHNICAL FIELD

The present disclosure relates to a polymerizable composition and the like.

### BACKGROUND ART

In recent years, a polymerizable composition has been used for bonding various members in manufacture of various devices. For example, Patent Literature 1 below describes a thermosetting composition containing a polymerizable compound.

### CITATION LIST

### Patent Literature

Patent Literature 1: Japanese Unexamined Patent Publication No. 2014-156522

### SUMMARY OF INVENTION

### Technical Problem

In recent years, in accordance with a reduction in size, high performance, and the like of various devices, there are a case where a polymerizable composition is thermally cured in the vicinity of a member that should not be exposed to high heat, a case where a polymerizable composition in contact with a member that should not be exposed to high heat is thermally cured, and the like. In these cases, from the viewpoint of avoiding deterioration of the member by performing thermal curing at a low temperature, it is required to lower a reaction initiation temperature for the polymerizable composition.

An object of one aspect of the present disclosure is to provide a polymerizable composition capable of lowering a reaction initiation temperature.

### Solution to Problem

The present disclosure relates to the following [1] to and the like in some aspects.
[1] A polymerizable composition containing a polymerizable compound, the polymerizable composition containing: (A) a borate anion; and (B) at least one selected from the group consisting of an aromatic carboxylic acid having two or more hydroxy groups, a salt of the aromatic carboxylic acid, and a hydrate of the aromatic carboxylic acid.
[2] The polymerizable composition according to [1], in which the component (A) includes a borate anion having a naphthalene ring.
[3] The polymerizable composition according to [1] or [2], in which the component (A) includes an alkyl triaryl borate anion.
[4] The polymerizable composition according to any one of [1] to [3], in which the number of naphthalene rings in the component (A) is 3.
[5] The polymerizable composition according to any one of [1] to [4], in which a content of a boron salt containing the component (A) is 0.01 to 20.00 mass %.
[6] The polymerizable composition according to any one of [1] to [5], in which the number of hydroxy groups in the aromatic carboxylic acid is 2.
[7] The polymerizable composition according to any one of [1] to [5], in which the number of hydroxy groups in the aromatic carboxylic acid is 3.
[8] The polymerizable composition according to any one of [1] to [7], in which a content of the component (B) is 0.01 to 10.00 mass %.
[9] The polymerizable composition according to any one of [1] to [8], in which a mass ratio of a content of the component (B) with respect to a content of a boron salt containing the component (A) is 0.01 to 10.00.
[10] The polymerizable composition according to any one of [1] to [9], in which the polymerizable compound includes a (meth)acrylate compound.
[11] The polymerizable composition according to any one of [1] to [10], further containing a polymerization initiator.

### Advantageous Effects of Invention

According to one aspect of the present disclosure, it is possible to provide a polymerizable composition capable of lowering a reaction initiation temperature.

### DESCRIPTION OF EMBODIMENTS

Hereinafter, embodiments of the present disclosure will be described in detail. However, the present disclosure is not limited to the following embodiments.

In the present specification, a numerical range indicated using “to” indicates a range including numerical values described before and after “to” as a minimum value and a maximum value, respectively. “A or more” of a numerical range means A and a range more than A. “A or less” of a numerical range means A and a range less than A. In a numerical range described in stages in the present specification, an upper limit value or a lower limit value of a numerical range of a certain stage can be arbitrarily combined with an upper limit value or a lower limit value of a numerical range of another stage. In a numerical range described in the present specification, an upper limit value or a lower limit value of the numerical range may be replaced with a value shown in Examples. “A or B” may include either A or B, and may include both A and B. Materials exemplified in the present specification can be used alone or in combination of two or more types thereof unless otherwise specified. When a plurality of substances corresponding to each component are present in the composition, the content of each component in the composition means the total amount of the plurality of substances present in the composition unless otherwise specified. The “(meth)acrylate” means at least one of an acrylate and a methacrylate corresponding thereto. The same applies to other similar expressions such as “(meth)acryl”. A content of the (meth)acrylate compound means a total amount of an acrylate compound and a methacrylate compound. The “alkyl group” may be linear, branched, or cyclic unless otherwise specified. The “hydroxy group” does not include an OH group contained in a carboxy group. The “total mass of the polymerizable composition” is a total mass of a solid content of the polymerizable composition. The solid content of the polymerizable composition refers to a nonvolatile content excluding volatile components (water, an organic solvent, and the like) that can be volatilized. That is, the solid content refers to a component that remains without being volatilized in drying of the polymerizable composition, and also includes a component in a liquid state, a syrup state, a wax state, or the like at 25° C.

In the present specification, the “weight average molecular weight” can be measured by performing conversion from a calibration curve using standard polystyrene by gel permeation chromatography (GPC) under the following measurement conditions.

### (Measurement Conditions)

Device: GPC-8020 manufactured by Tosoh Corporation
Detector: RI-8020 manufactured by Tosoh Corporation
Column: Gelpack GL-A-160-S+GL-A150 manufactured by Showa Denko Materials Co., Ltd.
Sample concentration: 120 mg/3 mL
Solvent: Tetrahydrofuran
Injection amount: 60 μL
Pressure: 294×10⁶ Pa (30 kgf/cm²)
Flow rate: 1.00 mL/min

A polymerizable composition of the present embodiment is a polymerizable composition containing a polymerizable compound, the polymerizable composition containing: (A) a borate anion (hereinafter, referred to as “component (A)” in some cases); and (B) at least one selected from the group consisting of an aromatic carboxylic acid having two or more hydroxy groups, a salt of the aromatic carboxylic acid, and a hydrate of the aromatic carboxylic acid (hereinafter, referred to as “component (B)” in some cases). Hereinafter, the aromatic carboxylic acid having two or more hydroxy groups is referred to as “aromatic carboxylic acid b”.

The polymerizable composition of the present embodiment contains at least one polymerizable compound, and as a polymerizable compound, may contain at least one selected from the group consisting of a compound containing the component (A) and the component (B), and may contain a polymerizable compound that does not correspond to at least one selected from the group consisting of a compound containing the component (A) and the component (B). In a case where at least one selected from the group consisting of a compound containing the component (A) and the component (B) is a polymerizable compound, the polymerizable composition of the present embodiment may contain a polymerizable compound that does not correspond to at least one selected from the group consisting of a compound containing the component (A) and the component (B).

The polymerizable composition of the present embodiment can be used as a thermosetting polymerizable composition. According to the polymerizable composition of the present embodiment, a reaction initiation temperature can be lowered. According to the polymerizable composition of the present embodiment, a reaction initiation temperature of, for example, 84.00° C. or lower (preferably, 80.00° C. or lower, 75.00° C. or lower, 70.00° C. or lower, or the like) can be obtained in an evaluation method described in Examples described below.

According to one aspect of the polymerizable composition of the present embodiment, as excellent storage stability related to the reaction initiation temperature, it is possible to suppress an increase in reaction initiation temperature when the polymerizable composition (for example, a film-shaped polymerizable composition) is stored, and for example, it is possible to suppress an increase in reaction initiation temperature when a film-shaped polymerizable composition is stored at 25° C. for 1 day (24 hours). According to one aspect of the polymerizable composition of the present embodiment, a rate of change in reaction initiation temperature of, for example, 20.00% or less (preferably, 15.00% or less, 10.00% or less, 5.00% or less, or the like) can be obtained in an evaluation method described in Examples described below.

The use of the polymerizable composition of the present embodiment is not particularly limited, and examples thereof include display devices, semiconductor devices, and members for electronic devices. The polymerizable composition of the present embodiment may be used in a micro LED (Light emitting diode), a micro OLED (Organic light emitting diode), and the like.

The polymerizable composition of the present embodiment contains a borate anion as the component (A). The polymerizable composition of the present embodiment may contain a boron salt containing a borate anion (a salt of the component (A) and a counter cation of the component (A), hereinafter, referred to as “component (al)”). In the polymerizable composition of the present embodiment, the component (A) may be bonded to a counter cation, and may be free without being bonded to a counter cation.

In the component (A), the number (the number in one molecule) of boron atoms may be 1 to 4, 1 to 3, or 1 to 2, from the viewpoint of easily lowering the reaction initiation temperature.

The component (A) may include a borate anion having a naphthalene ring (a substituted or unsubstituted naphthyl group), may include a borate anion having a naphthalene ring (substituted or unsubstituted naphthyl group) bonded to a boron atom, may include at least one selected from the group consisting of an alkyl triaryl borate anion and a tetraaryl borate anion, may include an alkyl triaryl borate anion, may include an alkyl trinaphthyl borate anion, may include a butyl trinaphthyl borate anion, and may include an n-butyl trinaphthyl borate anion, from the viewpoint of easily lowering the reaction initiation temperature.

In the component (A), the number (the number in one molecule) of naphthalene rings or the number (the number in one molecule) of naphthalene rings bonded to a boron atom may be 1 to 4, 1 to 3, 2 to 4, 2 to 3, or 3 to 4, and may be 3, from the viewpoint of easily lowering the reaction initiation temperature.

The component (A) may have an unsubstituted naphthalene ring and may have a naphthalene ring having a substituent. Examples of the substituent include a halogen atom, an alkyl group, an aryl group, and an alkoxy group.

The component (A) may have an alkyl group bonded to a boron atom from the viewpoint of easily lowering the reaction initiation temperature. In the component (A), the number (the number in one molecule) of alkyl groups bonded to a boron atom may be 1 to 3 or 1 to 2, from the viewpoint of easily lowering the reaction initiation temperature.

The number of carbon atoms in the alkyl group bonded to a boron atom may be in the following range from the viewpoint of easily lowering the reaction initiation temperature. The number of carbon atoms in the alkyl group may be 1 or more, 2 or more, 3 or more, or 4 or more. The number of carbon atoms in the alkyl group may be 12 or less, 10 or less, 8 or less, 6 or less, 5 or less, or 4 or less. From these viewpoints, the number of carbon atoms in the alkyl group may be 1 to 12, 1 to 8, 1 to 4, 2 to 12, 2 to 8, 2 to 4, 3 to 12, 3 to 8, 3 to 4, 4 to 12, or 4 to 8.

The component (A) may have a functional group other than a naphthalene ring (naphthyl group) and an alkyl group as a functional group bonded to a boron atom. Examples of such a functional group include an aryl group (for example, a phenyl group) other than a naphthyl group.

Examples of the counter cation in the component (al) include a quaternary ammonium ion, a tertiary ammonium ion, a secondary ammonium ion, a primary ammonium ion, an ammonium ion, an imidazolium ion, an imidazolinium ion, a pyridinium ion, an alkali metal ion (a sodium ion, a potassium ion, and the like), a phosphonium cation, a sulfonium cation, and an iodonium cation. The component (al) may not contain a metal ion and may contain a metal ion. Examples of the metal ion include an alkali metal ion (a sodium ion, a potassium ion, and the like). The component (al) may contain a quaternary ammonium ion as a counter cation from the viewpoint of easily lowering the reaction initiation temperature.

Examples of a substituent bonded to a nitrogen atom in the quaternary ammonium ion include an alkyl group and an aryl group (for example, a phenyl group). From the viewpoint of easily lowering the reaction initiation temperature, as a counter cation, the component (al) may contain a quaternary ammonium ion having an alkyl group bonded to a nitrogen atom, and may contain a quaternary ammonium ion having at least one selected from the group consisting of a linear alkyl group bonded to a nitrogen atom and a branched alkyl group bonded to a nitrogen atom.

The number of carbon atoms in the alkyl group bonded to the nitrogen atom may be in the following range from the viewpoint of easily lowering the reaction initiation temperature. The number of carbon atoms in the alkyl group may be 1 or more, 2 or more, 3 or more, or 4 or more. The number of carbon atoms in the alkyl group may be 18 or less, 16 or less, 14 or less, 12 or less, 10 or less, 8 or less, 6 or less, 5 or less, or 4 or less. From these viewpoints, the number of carbon atoms in the alkyl group may be 1 to 18, 1 to 8, 1 to 4, 2 to 6, 4 to 18, or 4 to 8.

Examples of the quaternary ammonium ion include a tetraalkylammonium ion, a trialkylammonium ion, a dialkylammonium ion, a monoalkylammonium ion, a tetraarylammonium ion, a triarylammonium ion, a diarylammonium ion, and a monoarylammonium ion. The component (al) may contain a tetraalkylammonium ion as a counter cation from the viewpoint of easily lowering the reaction initiation temperature.

Examples of the tetraalkylammonium ion include a tetramethylammonium ion, a tetraethylammonium ion, a tetrapropylammonium ion, a tetrabutylammonium ion (for example, a tetra-n-butylammonium ion), a tetrahexylammonium ion, a triethylmethylammonium ion, a tributylethylammonium ion, and a trimethyldecylammonium ion. The component (al) may contain a tetrabutylammonium ion as a counter cation from the viewpoint of easily lowering the reaction initiation temperature.

A content of the component (al) may be in the following range based on the total mass of the polymerizable composition. The content of the component (al) may be 0.01 mass % or more, 0.05 mass % or more, 0.10 mass % or more, 0.20 mass % or more, 0.30 mass % or more, 0.40 mass % or more, 0.50 mass % or more, 0.60 mass % or more, 0.70 mass % or more, 0.80 mass % or more, 0.90 mass % or more, 1.00 mass % or more, 1.10 mass % or more, or 1.20 mass % or more, from the viewpoint of easily lowering the reaction initiation temperature. The content of the component (al) may be 20.00 mass % or less, 15.00 mass % or less, 10.00 mass % or less, 8.00 mass % or less, 7.00 mass % or less, 6.00 mass % or less, 5.00 mass % or less, 4.00 mass % or less, 3.00 mass % or less, 2.00 mass % or less, 1.50 mass % or less, 1.20 mass % or less, 1.10 mass % or less, 1.00 mass % or less, 0.90 mass % or less, 0.80 mass % or less, 0.70 mass % or less, 0.60 mass % or less, 0.50 mass % or less, or 0.40 mass % or less, from the viewpoint of adjusting the reaction initiation temperature. From these viewpoints, the content of the component (al) may be 0.01 to 20.00 mass %, 0.30 to 20.00 mass %, 0.70 to 20.00 mass %, 1.00 to 20.00 mass %, 0.01 to 2.00 mass %, 0.30 to 2.00 mass %, 0.70 to 2.00 mass %, 1.00 to 2.00 mass %, 0.01 to 1.00 mass %, 0.30 to 1.00 mass %, or 0.70 to 1.00 mass %.

The polymerizable composition of the present embodiment contains, as the component (B), at least one selected from the group consisting of an aromatic carboxylic acid b, a salt of the aromatic carboxylic acid b, and a hydrate of the aromatic carboxylic acid b (with the proviso that a compound corresponding to the component (al) is excluded). Examples of the salt of the aromatic carboxylic acid b include alkali metal salts such as a sodium salt and a potassium salt. The at least one selected from the group consisting of the aromatic carboxylic acid b, the salt of the aromatic carboxylic acid b, and the hydrate of the aromatic carboxylic acid b (with the proviso that a compound corresponding to the component (al) is excluded) may be at least one selected from the group consisting of the aromatic carboxylic acid b and the hydrate of the aromatic carboxylic acid b, and may be the aromatic carboxylic acid b.

The aromatic carboxylic acid b has at least one aromatic ring. The number (the number in one molecule) of aromatic rings may be 1 from the viewpoint of easily lowering the reaction initiation temperature. Examples of the aromatic ring include a benzene ring and a naphthalene ring. The aromatic carboxylic acid b may include an aromatic carboxylic acid having a benzene ring from the viewpoint of easily lowering the reaction initiation temperature.

The aromatic carboxylic acid b has a carboxy group bonded to an aromatic ring. The aromatic carboxylic acid b may include an aromatic carboxylic acid having a hydroxy group (a phenolic hydroxyl group) bonded to an aromatic ring from the viewpoint of easily lowering the reaction initiation temperature and easily obtaining excellent storage stability related to the reaction initiation temperature. From the viewpoint of easily lowering the reaction initiation temperature and easily obtaining excellent storage stability related to the reaction initiation temperature, the aromatic carboxylic acid b may have a hydroxy group bonded at a para-position with respect to a carboxy group bonded to an aromatic ring, and may have one or two hydroxy groups bonded at a meta-position with respect to a carboxy group bonded to an aromatic ring.

In the aromatic carboxylic acid b, the number (the number in one molecule) of carboxy groups bonded to the aromatic ring may be 1 from the viewpoint of easily lowering the reaction initiation temperature and easily obtaining excellent storage stability related to the reaction initiation temperature. In the aromatic carboxylic acid b, the number (the number in one molecule) of hydroxy groups or the number (the number in one molecule) of hydroxy groups bonded to an aromatic ring may be 1 to 4, 1 to 3, 1 to 2, 2 to 4, 2 to 3, or 3 to 4, may be 2, and may be 3, from the viewpoint of easily lowering the reaction initiation temperature and easily obtaining excellent storage stability related to the reaction initiation temperature.

The aromatic ring of the aromatic carboxylic acid b may have a substituent other than a carboxy group and a hydroxy group, and may not have a substituent other than a carboxy group and a hydroxy group. Examples of the substituent include an alkyl group and an alkoxy group.

Examples of the aromatic carboxylic acid b include 3,4-dihydroxybenzoic acid (protocatechuic acid), 3,5-dihydroxybenzoic acid (α-resorcylic acid), 2,4-dihydroxybenzoic acid (β-resorcylic acid), 2,6-dihydroxybenzoic acid (γ-resorcylic acid), 2,3-dihydroxybenzoic acid (2-pyrocatechuic acid), 2,5-dihydroxybenzoic acid (gentisic acid), 2,4-dihydroxy-6-methylbenzoic acid (orsellinic acid), 3,4,5-trihydroxybenzoic acid (gallic acid), and phloroglucinol carboxylic acid. The aromatic carboxylic acid b may include at least one selected from the group consisting of 3,4-dihydroxybenzoic acid, 3,5-dihydroxybenzoic acid, 2,3-dihydroxybenzoic acid, 2,4-dihydroxybenzoic acid, 2,5-dihydroxybenzoic acid, 2,6-dihydroxybenzoic acid, and 3,4,5-trihydroxybenzoic acid, and may include at least one selected from the group consisting of 3,4-dihydroxybenzoic acid (protocatechuic acid) and 3,4,5-trihydroxybenzoic acid (gallic acid), from the viewpoint of easily lowering the reaction initiation temperature and easily obtaining excellent storage stability related to the reaction initiation temperature.

A content of the component (B) may be 50.00 mass % or more, more than 50.00 mass %, 70.00 mass % or more, 80.00 mass % or more, 90.00 mass % or more, 92.00 mass % or more, 95.00 mass % or more, 97.00 mass % or more, 98.00 mass % or more, 99.00 mass % or more, or substantially 100.00 mass %, based on the total amount of an aromatic carboxylic acid, a salt of an aromatic carboxylic acid, and a hydrate of an aromatic carboxylic acid contained in the polymerizable composition, from the viewpoint of easily lowering the reaction initiation temperature.

The content of the component (B) may be in the following range based on the total mass of the polymerizable composition. The content of the component (B) may be 0.01 mass % or more, 0.05 mass % or more, 0.10 mass % or more, 0.30 mass % or more, 0.50 mass % or more, 0.80 mass % or more, 1.00 mass % or more, 1.20 mass % or more, 1.30 mass % or more, 1.40 mass % or more, 1.50 mass % or more, 1.60 mass % or more, 1.80 mass % or more, or 2.00 mass % or more, from the viewpoint of easily lowering the reaction initiation temperature. The content of the component (B) may be 10.00 mass % or less, 8.00 mass % or less, 6.00 mass % or less, 5.00 mass % or less, 4.00 mass % or less, 3.00 mass % or less, 2.50 mass % or less, 2.00 mass % or less, 1.80 mass % or less, 1.60 mass % or less, 1.50 mass % or less, or 1.40 mass % or less, from the viewpoint of easily obtaining excellent storage stability related to the reaction initiation temperature. From these viewpoints, the content of the component (B) may be 0.01 to 10.00 mass %, 0.01 to 2.50 mass %, 0.01 to 2.00 mass %, 1.00 to 10.00 mass %, 1.00 to 2.50 mass %, 1.00 to 2.00 mass %, 1.50 to 10.00 mass %, 1.50 to 2.50 mass %, or 1.50 to 2.00 mass %.

A mass ratio RI of the content of the component (B) with respect to the content of the component (al) (component (B)/component (al)) may be in the following range from the viewpoint of easily lowering the reaction initiation temperature. The mass ratio RI may be 0.01 or more, 0.05 or more, 0.10 or more, 0.30 or more, 0.50 or more, 0.80 or more, 1.00 or more, 1.20 or more, 1.50 or more, 1.80 or more, 2.00 or more, 2.50 or more, 3.00 or more, 3.50 or more, 4.00 or more, or 5.00 or more. The mass ratio RI may be 10.00 or less, 8.00 or less, 6.00 or less, 5.00 or less, 4.00 or less, 3.50 or less, 3.00 or less, 2.50 or less, 2.00 or less, 1.80 or less, 1.50 or less, or 1.20 or less from the viewpoint of easily obtaining excellent storage stability related to the reaction initiation temperature. From these viewpoints, the mass ratio RI may be 0.01 to 10.00, 0.01 to 6.00, 0.01 to 3.00, 0.01 to 1.50, 1.00 to 10.00, 1.00 to 6.00, 1.00 to 3.00, 1.00 to 1.50, 1.50 to 10.00, 1.50 to 6.00, or 1.50 to 3.00.

The polymerizable composition of the present embodiment may contain a polymerizable compound (with the proviso that a compound corresponding to the component (al) or the component (B) is excluded) as the component (C).

Examples of the component (C) include a radical polymerizable compound, a cationic polymerizable compound, and an anionic polymerizable compound. The component (C) may include a radical polymerizable compound from the viewpoint of easily lowering the reaction initiation temperature.

Examples of the component (C) include a (meth)acrylate compound, a maleimide compound, a vinyl ether compound, an allyl compound, a styrene compound, a (meth)acrylamide compound, a nadi-imide compound, natural rubber, isoprene rubber, butyl rubber, nitrile rubber, butadiene rubber, styrene-butadiene rubber, acrylonitrile-butadiene rubber, carboxylated nitrile rubber, an epoxy compound, an oxetane compound, and a lactone compound. The component (C) may include a compound having an ethylenically unsaturated bond and may include a (meth)acrylate compound from the viewpoint of easily lowering the reaction initiation temperature.

Examples of the (meth)acrylate compound include (poly) urethane (meth)acrylate, epoxy (meth)acrylate, methyl (meth)acrylate, polyether (meth)acrylate, polyester (meth)acrylate, polybutadiene (meth)acrylate, silicone (meth)acrylate, ethyl (meth)acrylate, 2-cyanoethyl (meth)acrylate, 2-(2-ethoxyethoxy)ethyl (meth)acrylate, 2-ethoxyethyl (meth)acrylate, 2-ethylhexyl (meth)acrylate, n-hexyl (meth)acrylate, 2-hydroxyethyl (meth)acrylate, isopropyl (meth)acrylate, hydroxypropyl (meth)acrylate, isobutyl (meth)acrylate, isobornyl (meth)acrylate, isodecyl (meth)acrylate, isooctyl (meth)acrylate, n-lauryl (meth)acrylate, 2-methoxyethyl (meth)acrylate, 2-phenoxyethyl (meth)acrylate, tetrahydrofurfuryl (meth)acrylate, N,N-dimethylaminoethyl (meth)acrylate, N,N-dimethylaminopropyl (meth)acrylate, ethylene glycol di(meth)acrylate, diethylene glycol di(meth)acrylate, trimethylolpropane tri (meth)acrylate, tetramethylolmethane tetra(meth)acrylate, polyethylene glycol di(meth)acrylate, polyalkylene glycol di(meth)acrylate, cyclohexyl (meth)acrylate, dicyclopentenyl (meth)acrylate, dicyclopentenyloxyethyl (meth)acrylate, neopentyl glycol di(meth)acrylate, pentaerythritol (meth)acrylate, dipentaerythritol hexa (meth)acrylate, isocyanuric acid alkylene oxide modified di(meth)acrylate, isocyanuric acid alkylene oxide modified tri (meth)acrylate, tricyclodecanyl(meth)acrylate, dimethyloltricyclodecane di(meth)acrylate, 2-hydroxy-1,3-di(meth)acryloxypropane, 2,2-bis[4-((meth)acryloxymethoxy)phenyl]propane, and 2,2-bis[4-((meth)acryloxypolyethoxy)phenyl]propane. “Polyurethane (meth)acrylate” and “urethane (meth)acrylate” are collectively referred to as “(poly) urethane (meth)acrylate”. The component (C) may include a bifunctional (meth)acrylate compound.

The component (C) may include a urethane (meth)acrylate compound having a polycarbonate skeleton (hereinafter, referred to as “component (c1)”), may include a urethane (meth)acrylate compound having a structure derived from polycarbonate polyol, and may include a compound represented by the following General Formula (c1), from the viewpoint of easily lowering the reaction initiation temperature.

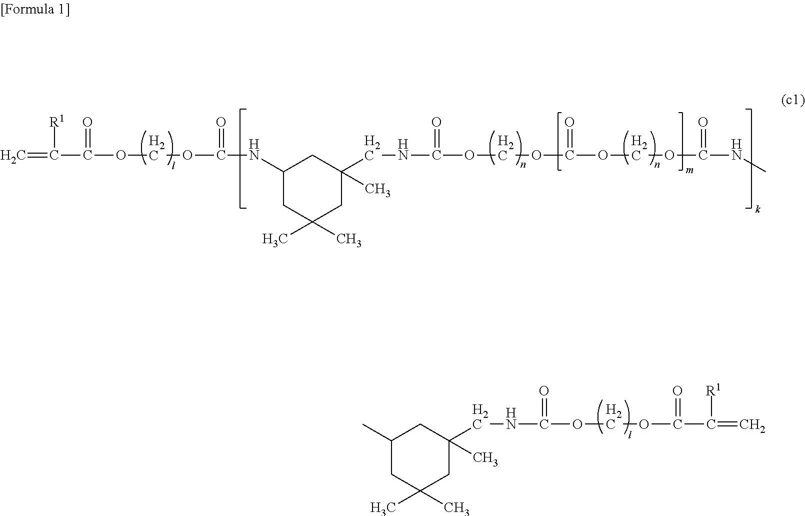

[In the formula, R1 represents a hydrogen atom or a methyl group, j represents an integer of 1 to 3, k represents an integer of 2 to 7, m represents an integer of 1 to 8, and n represents an integer of 5 to 7.]

In General Formula (c1), j may be 1 to 2 or 2 to 3, k may be 2 to 3 or 3 to 5, m may be 1 to 6, 1 to 4, or 1 to 2, and n may be 5 to 6 or 6 to 7, from the viewpoint of easily lowering the reaction initiation temperature.

A weight average molecular weight of the component (c1) may be 1000 or more, 3000 or more, 5000 or more, 8000 or more, 10000 or more, 12000 or more, 13000 or more, 14000 or more, or 15000 or more, from the viewpoint of easily lowering the reaction initiation temperature. The weight average molecular weight of the component (c1) may be 100000 or less, 50000 or less, 30000 or less, 25000 or less, 20000 or less, 18000 or less, or 15000 or less, from the viewpoint of easily lowering the reaction initiation temperature. From these viewpoints, the weight average molecular weight of the component (c1) may be 1000 to 100000, 5000 to 50000, or 10000 to 30000.

A content of the component (c1) may be in the following range based on the total mass of the component (C) from the viewpoint of easily lowering the reaction initiation temperature. The content of the component (c1) may be 10.00 mass % or more, 15.00 mass % or more, 20.00 mass % or more, 25.00 mass % or more, 30.00 mass % or more, 35.00 mass % or more, 40.00 mass % or more, 45.00 mass % or more, 50.00 mass % or more, or 55.00 mass % or more. The content of the component (c1) may be 90.00 mass % or less, 85.00 mass % or less, 80.00 mass % or less, 75.00 mass % or less, 70.00 mass % or less, 65.00 mass % or less, or 60.00 mass % or less. From these viewpoints, the content of the component (c1) may be 10.00 to 90.00 mass %, 10.00 to 80.00 mass %, 10.00 to 70.00 mass %, 20.00 to 90.00 mass %, 20.00 to 80.00 mass %, 20.00 to 70.00 mass %, 40.00 to 90.00 mass %, 40.00 to 80.00 mass %, or 40.00 to 70.00 mass %.

The content of the component (c1) may be in the following range based on the total mass of the polymerizable composition from the viewpoint of easily lowering the reaction initiation temperature. The content of the component (c1) may be 5.00 mass % or more, 10.00 mass % or more, 15.00 mass % or more, or 20.00 mass % or more. The content of the component (c1) may be 50.00 mass % or less, 45.00 mass % or less, 40.00 mass % or less, 35.00 mass % or less, 30.00 mass % or less, or 25.00 mass % or less. From these viewpoints, the content of the component (c1) may be 5.00 to 50.00 mass %, 5.00 to 40.00 mass %, 5.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

The component (C) may include an isocyanuric acid alkylene oxide-modified di(meth)acrylate (excluding a compound corresponding to the component (c1); hereinafter, referred to as “component (c2)”), and may include an isocyanuric acid ethylene oxide-modified di(meth)acrylate, from the viewpoint of easily lowering the reaction initiation temperature.

A content of the component (c2) may be in the following range based on the total mass of the component (C) from the viewpoint of easily lowering the reaction initiation temperature. The content of the component (c2) may be 1.00 mass % or more, 5.00 mass % or more, 10.00 mass % or more, 15.00 mass % or more, or 20.00 mass % or more. The content of the component (c2) may be 50.00 mass % or less, 45.00 mass % or less, 40.00 mass % or less, 35.00 mass % or less, 30.00 mass % or less, or 25.00 mass % or less. From these viewpoints, the content of the component (c2) may be 1.00 to 50.00 mass %, 1.00 to 40.00 mass %, 1.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

The content of the component (c2) may be in the following range based on the total mass of the polymerizable composition from the viewpoint of easily lowering the reaction initiation temperature. The content of the component (c2) may be 1.00 mass % or more, 3.00 mass % or more, 5.00 mass % or more, 8.00 mass % or more, or 9.00 mass % or more. The content of the component (c2) may be 30.00 mass % or less, 25.00 mass % or less, 20.00 mass % or less, 15.00 mass % or less, or 10.00 mass % or less. From these viewpoints, the content of the component (c2) may be 1.00 to 30.00 mass %, 1.00 to 20.00 mass %, 1.00 to 10.00 mass %, 5.00 to 30.00 mass %, 5.00 to 20.00 mass %, 5.00 to 10.00 mass %, 7.00 to 30.00 mass %, 7.00 to 20.00 mass %, or 7.00 to 10.00 mass %.

The component (C) may include a di(meth)acrylate compound (excluding a compound corresponding to the component (c1) or the component (c2); hereinafter, referred to as “component (c3)”) having at least one selected from the group consisting of a dicyclopentanyl structure and a dicyclopentenyl structure, and may include at least one selected from the group consisting of dimethyloltricyclodecane di(meth)acrylate and tricyclodecanediol di(meth)acrylate, from the viewpoint of easily lowering the reaction initiation temperature.

A content of the component (c3) may be in the following range based on the total mass of the component (C) from the viewpoint of easily lowering the reaction initiation temperature. The content of the component (c3) may be 1.00 mass % or more, 5.00 mass % or more, 10.00 mass % or more, 15.00 mass % or more, or 20.00 mass % or more. The content of the component (c3) may be 50.00 mass % or less, 45.00 mass % or less, 40.00 mass % or less, 35.00 mass % or less, 30.00 mass % or less, or 25.00 mass % or less. From these viewpoints, the content of the component (c3) may be 1.00 to 50.00 mass %, 1.00 to 40.00 mass %, 1.00 to 30.00 mass %, 10.00 to 50.00 mass %, 10.00 to 40.00 mass %, 10.00 to 30.00 mass %, 20.00 to 50.00 mass %, 20.00 to 40.00 mass %, or 20.00 to 30.00 mass %.

The content of the component (c3) may be in the following range based on the total mass of the polymerizable composition from the viewpoint of easily lowering the reaction initiation temperature. The content of the component (c3) may be 1.00 mass % or more, 3.00 mass % or more, 5.00 mass % or more, 8.00 mass % or more, or 9.00 mass % or more. The content of the component (c3) may be 30.00 mass % or less, 25.00 mass % or less, 20.00 mass % or less, 15.00 mass % or less, or 10.00 mass % or less. From these viewpoints, the content of the component (c3) may be 1.00 to 30.00 mass %, 1.00 to 20.00 mass %, 1.00 to 10.00 mass %, 5.00 to 30.00 mass %, 5.00 to 20.00 mass %, 5.00 to 10.00 mass %, 7.00 to 30.00 mass %, 7.00 to 20.00 mass %, or 7.00 to 10.00 mass %.

A content of the component (C) may be in the following range based on the total mass of the polymerizable composition from the viewpoint of easily lowering the reaction initiation temperature. The content of the component (C) may be 10.00 mass % or more, 15.00 mass % or more, 20.00 mass % or more, 25.00 mass % or more, 30.00 mass % or more, 35.00 mass % or more, or 40.00 mass % or more. The content of the component (C) may be 80.00 mass % or less, 75.00 mass % or less, 70.00 mass % or less, 65.00 mass % or less, 60.00 mass % or less, 55.00 mass % or less, 50.00 mass % or less, or 45.00 mass % or less. From these viewpoints, the content of the component (C) may be 10.00 to 80.00 mass %, 10.00 to 60.00 mass %, 10.00 to 50.00 mass %, 30.00 to 80.00 mass %, 30.00 to 60.00 mass %, 30.00 to 50.00 mass %, 35.00 to 80.00 mass %, 35.00 to 60.00 mass %, or 35.00 to 50.00 mass %.

A mass ratio R2 of the content of the component (C) with respect to the content of the component (al) (component (C)/component (al)) may be in the following range. The mass ratio R2 may be 1.00 or more, 5.00 or more, 10.00 or more, 20.00 or more, 30.00 or more, 40.00 or more, 50.00 or more, 60.00 or more, 80.00 or more, or 100.00 or more, from the viewpoint of adjusting the reaction initiation temperature. The mass ratio R2 may be 300.00 or less, 250.00 or less, 200.00 or less, 150.00 or less, 120.00 or less, 100.00 or less, 80.00 or less, 60.00 or less, 50.00 or less, or 40.00 or less, from the viewpoint of easily lowering the reaction initiation temperature. From these viewpoints, the mass ratio R2 may be 1.00 to 300.00, 1.00 to 120.00, 1.00 to 60.00, 1.00 to 40.00, 20.00 to 300.00, 20.00 to 120.00, 20.00 to 60.00, 20.00 to 40.00, 30.00 to 300.00, 30.00 to 120.00, 30.00 to 60.00, or 30.00 to 40.00.

A mass ratio R3 of the content of the component (C) with respect to the content of the component (B) (component (C)/component (B)) may be in the following range. The mass ratio R3 may be 1.00 or more, 5.00 or more, 10.00 or more, 15.00 or more, 20.00 or more, 25.00 or more, or 30.00 or more, from the viewpoint of easily obtaining excellent storage stability related to the reaction initiation temperature. The mass ratio R3 may be 300.00 or less, 200.00 or less, 100.00 or less, 80.00 or less, 50.00 or less, 45.00 or less, 40.00 or less, 35.00 or less, 30.00 or less, 25.00 or less, or 20.00 or less, from the viewpoint of easily lowering the reaction initiation temperature. From these viewpoints, the mass ratio R3 may be 1.00 to 300.00, 1.00 to 50.00, 1.00 to 30.00, 10.00 to 300.00, 10.00 to 50.00, 10.00 to 30.00, 20.00 to 300.00, 20.00 to 50.00, or 20.00 to 30.00.

The polymerizable composition of the present embodiment may contain a polymerization initiator (with the proviso that a compound corresponding to the component (al), the component (B), or the component (C) is excluded) as the component (D), and may not contain the polymerization initiator. The component (D) may include a thermal polymerization initiator. Examples of the component (D) include a radical polymerization initiator, a cationic polymerization initiator, and an anionic polymerization initiator. The component (D) may include a radical polymerization initiator from the viewpoint of easily lowering the reaction initiation temperature.

Examples of the component (D) include ketone peroxides such as methyl ethyl ketone peroxide, cyclohexanone peroxide, and methylcyclohexanone peroxide; peroxyketals such as 1,1-bis(tert-butylperoxy)cyclohexane, 1,1-bis(tert-butylperoxy)-2-methylcyclohexane, 1,1-bis(tert-butylperoxy)-3,3,5-trimethylcyclohexane, 1,1-bis(tert-hexylperoxy)cyclohexane, and 1,1-bis(tert-hexylperoxy)-3,3,5-trimethylcyclohexane; hydroperoxides such as p-menthane hydroperoxide; dialkyl peroxides such as α,α′-bis(tert-butylperoxy)diisopropylbenzene, dicumyl peroxide, tert-butylcumyl peroxide, and di-tert-butyl peroxide; diacyl peroxides such as octanoyl peroxide, lauroyl peroxide, stearyl peroxide, and benzoyl peroxide; peroxycarbonates such as bis(4-tert-butylcyclohexyl) peroxydicarbonate, di-2-ethoxyethyl peroxydicarbonate, di-2-ethylhexyl peroxydicarbonate, and di-3-methoxybutyl peroxydicarbonate; peroxy esters such as tert-butyl peroxypivalate, tert-hexyl peroxypivalate, 1,1,3,3-tetramethylbutylperoxy-2-ethylhexanoate, 2,5-dimethyl-2,5-bis(2-ethylhexanoylperoxy) hexane, tert-hexylperoxy-2-ethylhexanoate, tert-butylperoxy-2-ethylhexanoate, tert-butyl peroxyisobutyrate, tert-hexyl peroxyisopropyl monocarbonate, tert-butyl peroxy-3,5,5-trimethylhexanoate, tert-butyl peroxylaurate, tert-butyl peroxyisopropyl monocarbonate, tert-butylperoxy-2-ethylhexyl monocarbonate, tert-butyl peroxybenzoate, tert-hexyl peroxybenzoate, 2,5-dimethyl-2,5-bis(benzoylperoxy) hexane, and tert-butyl peroxyacetate; acid anhydrides such as phthalic anhydride, maleic anhydride, trimellitic anhydride, hexahydrophthalic anhydride, tetrahydrophthalic anhydride, methylnadic anhydride, nadic anhydride, glutaric anhydride, dimethylglutaric anhydride, diethylglutaric anhydride, succinic anhydride, methylhexahydrophthalic anhydride, methyltetrahydrophthalic anhydride, 1,2,3,4-cyclobutanetetracarboxylic dianhydride, 4,4′-biphthalic anhydride, 4,4′-carbonyldiphthalic anhydride, 4,4′-sulfonyldiphthalic anhydride, 4,4′-(hexafluoroisopropylidene)diphthalic anhydride, 4,4′-oxydiphthalic anhydride, 9,9-bis(3,4-dicarboxyphenyl) fluorene dianhydride, and 2,3,6,7-naphthalenetetracarboxylic dianhydride; azo compounds such as 2,2′-azobisisobutyronitrile, 2,2′-azobis(2,4-dimethylvaleronitrile), and 2,2′-azobis(4-methoxy-2′-dimethylvaleronitrile); iodonium salts; sulfonium salts; phosphonium salts; and imidazole compounds.

The component (D) may include a peroxide, may include an organic peroxide, and may include a diacyl peroxide, from the viewpoint of easily lowering the reaction initiation temperature.

A content of the component (D) may be in the following range based on the total mass of the polymerizable composition. The content of the component (D) may be 0.10 mass % or more, 0.50 mass % or more, 1.00 mass % or more, 1.50 mass % or more, 2.00 mass % or more, 2.50 mass % or more, 3.00 mass % or more, 3.50 mass % or more, 4.00 mass % or more, or 4.50 mass % or more, from the viewpoint of easily lowering the reaction initiation temperature. The content of the component (D) may be 20.00 mass % or less, 15.00 mass % or less, 10.00 mass % or less, 9.00 mass % or less, 8.00 mass % or less, 7.00 mass % or less, 6.00 mass % or less, or 5.00 mass % or less, from the viewpoint of adjusting the reaction initiation temperature. From these viewpoints, the content of the component (D) may be 0.10 to 20.00 mass %, 0.10 to 10.00 mass %, 0.10 to 5.00 mass %, 1.00 to 20.00 mass %, 1.00 to 10.00 mass %, 1.00 to 5.00 mass %, 3.00 to 20.00 mass %, 3.00 to 10.00 mass %, or 3.00 to 5.00 mass %.

A mass ratio R4 of the content of the component (D) with respect to the content of the component (al) (component (D)/component (al)) may be in the following range. The mass ratio R4 may be 0.10 or more, 0.50 or more, 1.00 or more, 2.00 or more, 3.00 or more, 4.00 or more, 5.00 or more, 6.00 or more, 8.00 or more, or 10.00 or more, from the viewpoint of adjusting the reaction initiation temperature. The mass ratio R4 may be 50.00 or less, 30.00 or less, 20.00 or less, 15.00 or less, 10.00 or less, 8.00 or less, 6.00 or less, 5.00 or less, or 4.00 or less, from the viewpoint of easily lowering the reaction initiation temperature. From these viewpoints, the mass ratio R4 may be 0.10 to 50.00, 0.10 to 15.00, 0.10 to 6.00, 0.10 to 5.00, 3.00 to 50.00, 3.00 to 15.00, 3.00 to 6.00, 3.00 to 5.00, 5.00 to 50.00, 5.00 to 15.00, or 5.00 to 6.00.

A mass ratio R5 of the content of the component (D) with respect to the content of the component (B) (component (D)/component (B)) may be in the following range. The mass ratio R5 may be 0.10 or more, 0.50 or more, 1.00 or more, 1.50 or more, 2.00 or more, 2.50 or more, 3.00 or more, or 3.50 or more, from the viewpoint of easily obtaining excellent storage stability related to the reaction initiation temperature. The mass ratio R5 may be 50.00 or less, 30.00 or less, 20.00 or less, 15.00 or less, 10.00 or less, 8.00 or less, 5.00 or less, 4.00 or less, 3.50 or less, 3.00 or less, 2.50 or less, or 2.00 or less, from the viewpoint of easily lowering the reaction initiation temperature. From these viewpoints, the mass ratio R5 may be 0.10 to 50.00, 0.10 to 20.00, 0.10 to 3.00, 1.00 to 50.00, 1.00 to 20.00, 1.00 to 3.00, 2.00 to 50.00, 2.00 to 20.00, or 2.00 to 3.00.

A mass ratio R6 of the content of the component (D) with respect to the content of the component (C) (component (D)/component (C)) may be in the following range. The mass ratio R6 may be 0.01 or more, 0.03 or more, 0.05 or more, 0.08 or more, or 0.10 or more, from the viewpoint of easily lowering the reaction initiation temperature. The mass ratio R6 may be 5.00 or less, 3.00 or less, 1.00 or less, 0.50 or less, 0.30 or less, 0.20 or less, or 0.15 or less, from the viewpoint of adjusting the reaction initiation temperature. From these viewpoints, the mass ratio R6 may be 0.01 to 5.00, 0.01 to 1.00, 0.01 to 0.50, 0.05 to 5.00, 0.05 to 1.00, 0.05 to 0.50, 0.10 to 5.00, 0.10 to 1.00, or 0.10 to 0.50.

The polymerizable composition of the present embodiment may contain a thermoplastic resin as the component (E), and may not contain a thermoplastic resin.

Examples of the component (E) include a phenoxy resin, polyester, polyurethane (excluding polyester urethane), polyester urethane, an ethylene-vinyl acetate copolymer, and a butyral resin. The component (E) may include at least one selected from the group consisting of polyester urethane and an ethylene-vinyl acetate copolymer from the viewpoint of easily lowering the reaction initiation temperature.

A content of the component (E) may be in the following range based on the total mass of the polymerizable composition from the viewpoint of easily lowering the reaction initiation temperature. The content of the component (E) may be 10.00 mass % or more, 15.00 mass % or more, 20.00 mass % or more, 25.00 mass % or more, 30.00 mass % or more, 35.00 mass % or more, 40.00 mass % or more, 45.00 mass % or more, or 50.00 mass % or more. The content of the component (E) may be 90.00 mass % or less, 85.00 mass % or less, 80.00 mass % or less, 75.00 mass % or less, 70.00 mass % or less, 65.00 mass % or less, 60.00 mass % or less, or 55.00 mass % or less. From these viewpoints, the content of the component (E) may be 10.00 to 90.00 mass %, 10.00 to 70.00 mass %, 10.00 to 60.00 mass %, 30.00 to 90.00 mass %, 30.00 to 70.00 mass %, 30.00 to 60.00 mass %, 40.00 to 90.00 mass %, 40.00 to 70.00 mass %, or 40.00 to 60.00 mass %.

The polymerizable composition of the present embodiment may contain a component other than the components described above. Examples of such a component include water, an organic solvent, a coupling agent, a filler, a softener, an accelerator, a deterioration inhibitor, a colorant, a flame retardant, and a thixotropic agent. The polymerizable composition of the present embodiment may contain at least one of these components, and may not contain at least one of these components.

The polymerizable composition of the present embodiment may be in the form of a film. A thickness of a film-shaped polymerizable composition or a thickness of a cured product of the present embodiment may be in the following range. The thickness may be 1 μm or more, 3 μm or more, 5 μm or more, 8 μm or more, 10 μm or more, 12 μm or more, 15 μm or more, 18 μm or more, or 20 μm or more. The thickness may be 500 μm or less, 300 μm or less, 200 μm or less, 100 μm or less, 80 μm or less, 50 μm or less, 30 μm or less, or 20 μm or less. From these viewpoints, the thickness may be 1 to 500 μm, 1 to 100 μm, 1 to 50 μm, 5 to 500 μm, 5 to 100 μm, 5 to 50 μm, 10 to 500 μm, 10 to 100 μm, or 10 to 50 μm.

### EXAMPLES

Hereinafter, the present disclosure will be further described using Examples and Comparative Examples, but the present disclosure is not limited to Examples below.

### Synthesis of Urethane Acrylate (UA1)

To a reaction vessel equipped with a stirrer, a thermometer, a reflux condenser having a calcium chloride drying tube, and a nitrogen gas introduction tube, 2500 parts by mass (2.50 mol) of poly(1,6-hexanediol carbonate) (trade name: DURANOL T5652, manufactured by Asahi Kasei Chemicals Corporation) and 666 parts by mass (3.00 mol) of isophorone diisocyanate (manufactured by Sigma-Aldrich Co. LLC) were uniformly added dropwise for 3 hours. Next, a sufficient amount of nitrogen gas was introduced into the reaction vessel, and then, the inside of the reaction vessel was heated to 70 to 75° C. for reaction. Next, 0.53 parts by mass (4.3 mmol) of hydroquinone monomethyl ether (manufactured by Sigma-Aldrich Co. LLC) and 5.53 parts by mass (8.8 mmol) of dibutyltin dilaurate (manufactured by Sigma-Aldrich Co. LLC) were added to the reaction vessel, 238 parts by mass (2.05 mol) of 2-hydroxyethyl acrylate (manufactured by Sigma-Aldrich Co. LLC) was added, and then, a reaction was performed at 70° C. for 6 hours in an air atmosphere. As a result, urethane acrylate (UA1) having a polycarbonate skeleton was obtained. The weight average molecular weight of the polyurethane acrylate (UA1) was 15000.

### Synthesis of Polyester Urethane (EU1)

48 parts by mass of isophthalic acid and 37 parts by mass of neopentyl glycol were added to a stainless steel autoclave with a heater equipped with a stirrer, a thermometer, a condenser, a vacuum generator, and a nitrogen gas introduction tube, and then, 0.02 parts by mass of tetrabutoxy titanate was added as a catalyst. Next, the temperature was raised to 220° C. under a nitrogen stream, and stirring was performed for 8 hours as it was. Thereafter, the pressure was reduced to atmospheric pressure (760 mmHg) and cooled to room temperature. As a result, a white precipitate was precipitated, and then, this precipitate was taken out. This precipitate was washed with water and then vacuum-dried to obtain a polyester polyol. This polyester polyol was sufficiently dried, then dissolved in MEK (methyl ethyl ketone), and added to a four-neck flask equipped with a stirrer, a dropping funnel, a reflux condenser, and a nitrogen gas introduction tube. In addition, dibutyltin dilaurate (catalyst) was added in an amount of 0.05 parts by mass with respect to 100 parts by mass of the polyester polyol, and 4,4′-diphenylmethane diisocyanate was dissolved in MEK in an amount of 50 parts by mass with respect to 100 parts by mass of the polyester polyol and added through a dropping funnel. Then, stirring was performed at 80° C. for 4 hours to obtain polyester urethane (EU1).

### Preparation of Polymerizable Composition

A polymerizable composition was prepared by mixing a methyl ethyl ketone solution (solid content ratio: 20 mass %) of a boron salt (tetrabutylammonium=butyl trinaphthyl borate, manufactured by Showa Denko K.K., trade name: Karenz N3B), an acid component shown in Table 1, a toluene solution (solid content ratio: 20 mass %) of a polymerization initiator (diacyl peroxide, manufactured by NOF CORPORATION, trade name: PEROYL-L), urethane acrylate (UA1), isocyanuric acid ethylene oxide-modified diacrylate (trade name: M-215, manufactured by Toagosei Co., Ltd.), dimethyloltricyclodecane diacrylate (trade name: Light Acrylate DCP-A, manufactured by Kyoeisha Chemical Co., Ltd.), a methyl ethyl ketone/toluene mixed solution (mass ratio: 1/1, solid content ratio: 40 mass %) of polyester urethane (EU1), and a toluene solution (solid content ratio: 30 mass %) of an ethylene-vinyl acetate copolymer (trade name: EV40W, manufactured by DuPont de Nemours, Inc.). The amounts (solid content, unit: parts by mass) of the boron salt and the acid component are shown in Table 1. The amount of the 3,4,5-trihydroxybenzoic acid (gallic acid) is the amount of the 3,4,5-trihydroxybenzoic acid monohydrate. The amount (solid content) of the polymerization initiator was 5.00 parts by mass, the amount of the urethane acrylate (UA1) was 25.00 parts by mass, the amount of the isocyanuric acid ethylene oxide-modified diacrylate was 10.00 parts by mass, the amount of the dimethyloltricyclodecane diacrylate was 10.00 parts by mass, the amount (solid content) of the polyester urethane (EU1) was 47.50 parts by mass, and the amount (solid content) of the ethylene-vinyl acetate copolymer was 7.50 parts by mass.

In the respective Examples and Comparative Examples, the following acid components shown in “Acid component (type)” in Table 1 were used.
3,4-Dihydroxybenzoic acid (protocatechuic acid): manufactured by FUJIFILM Wako Pure Chemical Corporation
3,5-Dihydroxybenzoic acid (α-resorcylic acid): manufactured by Tokyo Chemical Industry Co., Ltd.
2,3-Dihydroxybenzoic acid (2-pyrocatechuic acid): manufactured by Tokyo Chemical Industry Co., Ltd.
2,4-Dihydroxybenzoic acid (β-resorcylic acid): manufactured by FUJIFILM Wako Pure Chemical Corporation
2,5-Dihydroxybenzoic acid (gentisic acid): manufactured by FUJIFILM Wako Pure Chemical Corporation
2,6-Dihydroxybenzoic acid (γ-resorcylic acid): manufactured by FUJIFILM Wako Pure Chemical Corporation
3,4,5-Trihydroxybenzoic acid (gallic acid) (monohydrate): manufactured by FUJIFILM Wako Pure Chemical Corporation
Acetic acid: manufactured by FUJIFILM Wako Pure Chemical Corporation
Adipic acid: manufactured by FUJIFILM Wako Pure Chemical Corporation
p-Hydroxybenzoic acid: manufactured by FUJIFILM Wako Pure Chemical Corporation

### Preparation of Laminated Film

The above-mentioned polymerizable composition was applied to a PET film (with peeling treatment: thickness: 50 μm) using a bar coater (trade name “KNIFE COATER SNC-300”, manufactured by Yasui Seiki Inc.), and then dried in an oven at 60° C. for 3 minutes, thereby preparing a laminated film having a 20 μm-thick film-shaped polymerizable composition disposed on the PET film.

### <Measurement of Reaction Initiation Temperature>

After the PET film was peeled off from the above-mentioned laminated film immediately after the preparation, a curing exothermic behavior of the film-shaped polymerizable composition was measured by differential scanning calorinetry (hereinafter, referred to as “DSC”), and an onset temperature of an exothermic peak was obtained as an index of the reaction initiation temperature of polymerization. DSC measurement was performed under the conditions below to obtain a reaction initiation temperature T1. In addition, the above-mentioned laminated film immediately after preparation in Examples was placed in a nylon poly bag (trade name “Nylon Poly S Type”, manufactured by Fukusuke Kogyo Co., Ltd.), and then this bag was sealed using a vacuum degassing sealer to enclose the laminated film. Further, this bag was put in a light-shielding bag formed of aluminum. In this state, the laminated film was allowed to stand at 25° C. for 24 hours, the laminated film was taken out from the light-shielding bag, and then, a reaction initiation temperature T2 was obtained by the same procedure as described above. Then, “[(T2-T1)/T1]×100” was calculated as a rate of change (%) of reaction initiation temperature. The results thereof are shown in Table 1.

### (DSC Measurement Conditions)

Measuring apparatus: trade name “DSC8500”, manufactured by PerkinElmer Japan Co., Ltd.
Sample amount: 10.0±0.2 mg
Measurement temperature range: 30 to 200° C.
Heating rate: 30° C./min
Measurement atmosphere: nitrogen

TABLE 1

| | | | | | Reaction initiation | | |
|---|---|---|---|---|---|---|---|
| | | | Amount | | temperature | | |
| | | | [parts by mass] | | | | Rate of |
| | | Acid component | | Acid | T1 | T2 | change |
| | | (type) | Borate | component | [° C.] | [° C.] | [%] |
| Example | 1 | 3,4-Dihydroxybenzoic acid | 0.43 | 1.41 | 69.40 | 71.32 | 2.77 |
| | 2 | 3,4-Dihydroxybenzoic acid | 0.43 | 2.11 | 66.22 | 75.47 | 13.97 |
| | 3 | 3,4-Dihydroxybenzoic acid | 0.86 | 1.41 | 65.28 | 69.60 | 6.62 |
| | 4 | 3,4-Dihydroxybenzoic acid | 1.29 | 1.41 | 62.79 | 65.48 | 4.28 |
| | 5 | 3,5-Dihydroxybenzoic acid | 1.29 | 1.41 | 74.01 | 78.93 | 6.65 |
| | 6 | 2,3-Dihydroxybenzoic acid | 1.29 | 1.41 | 51.39 | 81.17 | 57.95 |
| | 7 | 2,4-Dihydroxybenzoic acid | 1.29 | 1.41 | 64.41 | 74.73 | 16.02 |
| | 8 | 2,5-Dihydroxybenzoic acid | 1.29 | 1.41 | 54.49 | 81.06 | 48.76 |
| | 9 | 2,6-Dihydroxybenzoic acid | 1.29 | 1.41 | 69.53 | 93.15 | 33.97 |
| | 10 | 3,4,5-Trihydroxybenzoic acid | 0.43 | 1.72 | 75.20 | 74.80 | −0.53 |
| | 11 | 3,4,5-Trihydroxybenzoic acid | 0.43 | 2.58 | 67.31 | 76.33 | 13.40 |
| | 12 | 3,4,5-Trihydroxybenzoic acid | 0.86 | 1.72 | 64.82 | 66.80 | 3.05 |
| Comparative | 1 | Acetic acid | 0.43 | 0.27 | 88.18 | | |
| Example | 2 | Adipic acid | 0.43 | 0.67 | 88.16 | | |
| | 3 | p-Hydroxybenzoic acid | 0.43 | 1.26 | 84.90 | | |

1. A polymerizable composition comprising a polymerizable compound, the polymerizable composition comprising:
(A) a borate anion; and (B) at least one selected from the group consisting of an aromatic carboxylic acid having two or more hydroxy groups, a salt of the aromatic carboxylic acid, and a hydrate of the aromatic carboxylic acid.

2. The polymerizable composition according to claim 1, wherein the component (A) includes a borate anion having a naphthalene ring.

3. The polymerizable composition according to claim 1, wherein the component (A) includes an alkyl triaryl borate anion.

4. The polymerizable composition according to claim 1, wherein the number of naphthalene rings in the component (A) is 3.

5. The polymerizable composition according to claim 1, wherein a content of a boron salt containing the component (A) is 0.01 to 20.00 mass %.

6. The polymerizable composition according to claim 1, wherein the number of hydroxy groups in the aromatic carboxylic acid is 2.

7. The polymerizable composition according to claim 1, wherein the number of hydroxy groups in the aromatic carboxylic acid is 3.

8. The polymerizable composition according to claim 1, wherein a content of the component (B) is 0.01 to 10.00 mass %.

9. The polymerizable composition according to claim 1, wherein a mass ratio of a content of the component (B) with respect to a content of a boron salt containing the component (A) is 0.01 to 10.00.

10. The polymerizable composition according to claim 1, wherein the polymerizable compound includes a (meth)acrylate compound.

11. The polymerizable composition according to claim 1, further comprising a polymerization initiator.

12. The polymerizable composition according to claim 1, wherein the polymerizable composition is in the form of a film.

13. The polymerizable composition according to claim 1, wherein the component (A) has an alkyl group bonded to a boron atom.

14. The polymerizable composition according to claim 13, wherein the number of carbon atoms in the alkyl group bonded to the boron atom is 2 to 6.

15. The polymerizable composition according to claim 1, comprising a boron salt containing the component (A), wherein
the boron salt contains a quaternary ammonium ion as a counter cation.

16. The polymerizable composition according to claim 15, wherein the boron salt contains, as a counter cation, a quaternary ammonium ion having an alkyl group bonded to a nitrogen atom.

17. The polymerizable composition according to claim 16, wherein the number of carbon atoms in the alkyl group bonded to the nitrogen atom is 2 to 6.

18. The polymerizable composition according to claim 15, wherein the quaternary ammonium ion includes at least one selected from the group consisting of a tetraalkylammonium ion, a trialkylammonium ion, a dialkylammonium ion, a monoalkylammonium ion, a tetraarylammonium ion, a triarylammonium ion, a diarylammonium ion, and a monoarylammonium ion.

19. The polymerizable composition according to claim 15, wherein the boron salt contains a tetraalkylammonium ion as a counter cation.

20. The polymerizable composition according to claim 1, wherein the component (C) includes a radical polymerizable compound.
